(19) United States
(12) Patent Application Publication
(10) Pub. No.: US 2016/0380780 A1
(43) Pub. Date: Dec. 29, 2016

(54) Systems and Methods for Simultaneously Sharing Media Over a Network

(71) Applicant: Collaboration Solutions, Inc., North Hollywood, CA (US)

(72) Inventors: Jack Stephenson, Bellevue, WA (US); Jeremy Short, Studio City, CA (US); Christopher Cecil, Sherman Oaks, CA (US)

(21) Appl. No.: 14/749,793

(22) Filed: Jun. 25, 2015

(51) Int. Cl. H04L 12/18; H04L 29/06; H04L 12/58

(52) U.S. Cl. CPC H04L 12/1845; H04L 51/10; H04L 65/605

(57) ABSTRACT

Systems and methods presented herein may allow a sending user to collaboratively share media content with recipients such that each recipient may control media playback, and the controls effect the playback experienced by the other recipients. The net result is a shared media player. The recipients may all execute a common client software on their computing devices that causes the computing devices to stream the media from a content provider but route playback control selections to a server that then transmits the selections to the other recipients in real time.

### FIELD OF THE EMBODIMENTS

The embodiments relate generally to systems and methods for sharing media over a network, and, more specifically, to systems and methods for sharing media with users simultaneously such that multiple users consume the media at the same time.

### BACKGROUND

People typically share media files by attaching them to an email and sending them to another person. This has several shortcomings. First, the act of attaching and emailing the media file can be cumbersome, particularly when multiple recipients are needed. Not only does the user have to locate the email address of each recipient, but some email accounts have file size limitations that may block the email. This is because the size of media files can range wildly based on file type. For example, a .WAV may be 40 MB and a .AVI video file may be even larger. Additionally, the length of the media directly impacts the size of the media file(s).

Second, sharing media in this manner can have other problematic effects when the copyright owner of the media wishes to control its dissemination. This is because a media file is permanent and can be easily replicated, allowing any recipient to pass a copy of the media file onward any number of times. The music and film industries in particular constantly guard against this, both with released and unreleased media. Media files that are in production may be passed around for input from producers, executives, and any number of other advisors or participants. This can result in many copies of an otherwise private media file. All too often, someone will gain access to the media and post it on the Internet for anyone to access—for example, leaking a song before the artist or record label intended.

Additionally, media may be shared using conferencing solutions. But existing conferencing solutions may reduce media quality and fail to provide an easy mechanism for multiple users to control the media. In particular, a user may share their screen, but this may consist of the user's computer capturing activity on the screen and broadcasting that out to other users. The result is often a choppy video and poor quality audio experience that is not useful in situations where high quality video or audio is needed.

Therefore, a need exists for systems and methods for sharing media over a network, and, more specifically, to systems and methods for sharing media with users simultaneously such that multiple users consume the media at the same time without downloading the entire media file.

### SUMMARY

Embodiments described herein include systems and methods for temporarily sharing media over a network. In one embodiment, a system for sharing media may include a server in communication with a plurality of recipient devices. The server may perform stages that include receiving, from a first device, a request to initate a shared media player session, which can include an identification of media content to share. The server can then generate a one-time credential to access the media content, which can be sent to rest of the plurality of recipients.

Recipients may then go to a location supplied by the server and utilize the credential to join a shared media player session. In the session, the recipients can all control playback of the media content in an embodiment by accessing a website or other portal controlled by the server. The server replicates each control command to the other recipients, which provides a substantially synchronized experience. When one of the recipients plays the media file, the file may also play on all other recipient's devices that are logged into the server. When one of the recipients pauses or rewinds the media, the media also pauses or rewinds on all other recipients devices that are logged into the server. In this way, multiple users can collaborate regarding the media, with shared controls and simultaneous streaming to each device.

Various options for restricting playback may be available to the sender. For example, in one embodiment, the sharing selections may include a time limit that recipients may have access to the media. In another embodiment, the sharing selections may include a start date and/or time for when the media file will be available to a plurality of users in the recipient selection. In a further embodiment, a watermark may be blended into the streamed media, which may help the user track the source of leaked media.

It is to be understood that both the foregoing general description and the following detailed description are exemplary and explanatory only and are not restrictive of the embodiments, as claimed.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is an exemplary illustration of a system for sharing media over a network, in accordance with an embodiment;

FIG. 2 is an exemplary illustration of a system for sharing media over a network, in accordance with an embodiment;

FIG. 3 is an exemplary illustration of example components utilized a system for sharing media over a network, in accordance with an embodiment;

FIGS. 4A-B are exemplary illustrations of a webpage interface that may be incorporated in a system for sharing media over a network, in accordance with an embodiment;

FIG. 5 is an exemplary flow chart with non-exhaustive listings of steps that may be performed by a server, in accordance with an embodiment; and

FIG. 6 is an exemplary flow chart with non-exhaustive listings of steps that may be performed by a recipient computing device, in accordance with an embodiment.

### DESCRIPTION OF THE EMBODIMENTS

Reference will now be made in detail to the present exemplary embodiments, including examples illustrated in the accompanying drawings. Wherever possible, the same reference numbers will be used throughout the drawings to refer to the same or like parts.

Exemplary embodiments herein allow a user to transmit and share media with a plurality of recipients such that the media is not saved locally on the recipient's computing device, controls for consumption are shared amongst recipients, and consumption occurs substantially simultaneously amongst the recipients. The media may be a presentation, a video clip, a movie, a song, a portion of a movie or song, an audio book, or any other media that the user may wish to share.

In one embodiment, a server allows recipients to access a browser-based portal. Web Services including asynchronous I/O may be used to establish a session and provide an event-driven communication bus between endpoints (e.g., recipients) while minimizing overhead and maximizing scalability. This may allow endpoints to communicate play, pause, and seek events, as well as synchronize near real-time playback locations within the media.

Unlike traditional unicast/multicast approaches, a system herein stages content for streaming from a commonly accessible Content Delivery Network (CDN). To facilitate this, the system also supports uploading media files. All web traffic can be secured using secure socket layer (SSL) in an embodiment, such that individual users never know the location of cached files. Staged files are deleted after they are played or other criteria are met.

A system herein may, for example, allow a film maker to share a video preview with executives at a media company. It may also allow a musician or producer to send a demo track to multiple potential producers or record label representatives without fear that the recipient may then pass the track to others who may copy or leak the media without permission. And it may further facilitate collaboration around the media by ensuring that the media is consumed uniformly across the recipients, including actions such as pausing the media or skipping to different locations within the media.

As used herein, the term “media file” may refer to any digitally-stored video or audio regardless of format, including .AVI, .MPEG, .WAV, .AIFF, .MP3, .MP4, SDII, AC3, DSD, or any number of file formats.

As used herein, the term “media associated with the media file” may refer to the same information contained in the media file or instead a representation of at least a portion of that information. For example, audio streamed at a different bit rate or sample rate for a thirty-second portion of the audio file would be considered media associated with the media file.

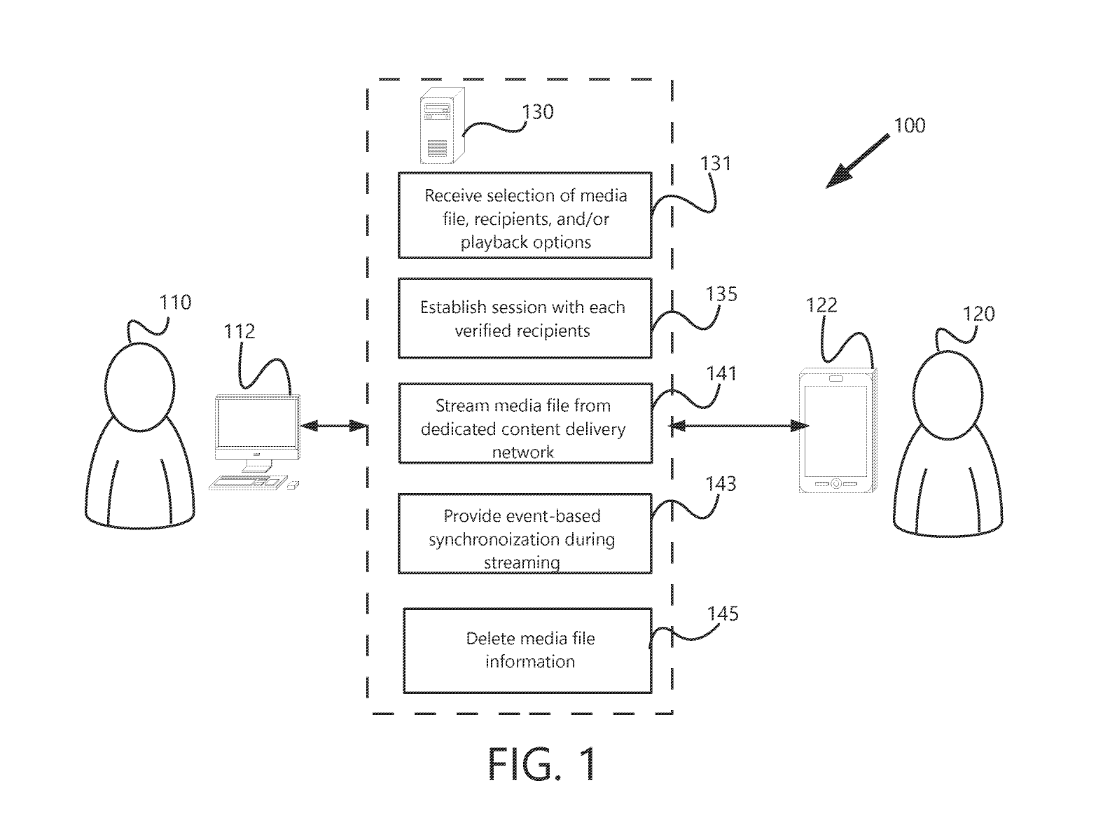

FIG. 1 shows an exemplary illustration of a simplified system 100 for collaboratively sharing media content. In this example, a user (i.e., sender) 110 at a first computing device 112 may attempt to collaboratively share media content, such as a video presentation he or she created, with at least one recipient 120. The computing device 112 can connect to a server 130 that may facilitate the collaborative sharing with recipient devices such as first recipient device 122.

Each computing device 112 or 122 may be any processor- or controller-based device for displaying, storing, receiving, and transmitting information. For example, computing device 112 can be a cell phone, smart phone, tablet, laptop, personal computer, or television. Other examples of computing device 112 include any portable or non-portable, processor- or controller-based device. Additional example computing devices 112 are discussed below, and any device capable of displaying the content discussed herein is contemplated.

The server 130 can include a computer-readable medium containing instructions that are executed by a processor in the server 130, causing the server 130 to carry out stages necessary to tempo collaboratively sharing media content. The first user 110 and any recipients 120 may access the server over a network, such as the Internet. In one embodiment, the computing devices 112 and 122 execute a browser to access a website run by the server 130.

At stage 131, the server 130 receives a selection of a media file from a first user. This may occur through the first user supplying either a link to the media content or uploading a file to the server 130. For example, the user 110 may be presented with a graphical user interface (“GUI”) that includes various options for selecting a media file to collaboratively share, along with various restrictions on how media content may be consumed by one or more recipients.

In one embodiment, the GUI may be presented as part of an application that resides and runs on the first device 112. In another embodiment, the GUI may at least partially be executed based on a connection with a network server, for example, in a software as a service (SAAS) implementation. For example, the GUI may be accessed by logging into a website in one embodiment. In another embodiment, both a local application and a website are options that the user may choose from when setting up a media content sharing request.

The GUI may allow the user 110 to select a list of intended recipients that the server 130 may contact with a passcode and/or link to begin the shared media consumption.

At stage 131 the user 110 may also select playback options (e.g., restrictions). The playback restrictions can include a time limit or time frame for how long the media content will be accessible, or placing a watermark into the media content to deter unauthorized copying and distribution.

The watermark may be added by the server when the media file is uploaded in one embodiment. The watermark may contain coded information that indicates which user uploaded the media file and when the upload occurred. The watermarked media may then be transferred to a content delivery network 138.

At stage 135, the server 135 may establish a collaborative playback session with recipients that attempt to access the media content. When recipient devices 122 log into the server to retrieve the media content, the server 130 may cause a module to execute on each recipient device 122. The module may can execute within a web browser and allow each recipient device 122 to control streaming, which impacts both their streaming experience and the streaming experience for the other recipients.

At stage 141, once any one of the recipients or the first user 110 has initiated playback, each recipient 120 may begin streaming the media content to their respective device 122. The streaming may be limited based on the selectable playback restrictions. The streaming may be initiated at a dedicated content delivery server, such that the media content is delivered to each recipient device at the highest quality that respective device is capable of receiving and playing.

One of the recipients may select a playback option, such as pause, rewind, or a location within the media content. In response, at stage 143 the server 130 provides event-based synchronization to the other recipient devices 122 by causing the same playback option to be selected and, if needed, the location to be chosen. This can keep playback substantially synchronized between the recipient devices 122 (exact synchronization to the millisecond is likely unimportant).

After the session has ended, the server 130 may cause the media content to be deleted at step 145. For example, the server 130 can delete the media file after a user-specified amount of days or time has elapsed, which may help guard against attempts to hack the software and illegally obtain the media file.

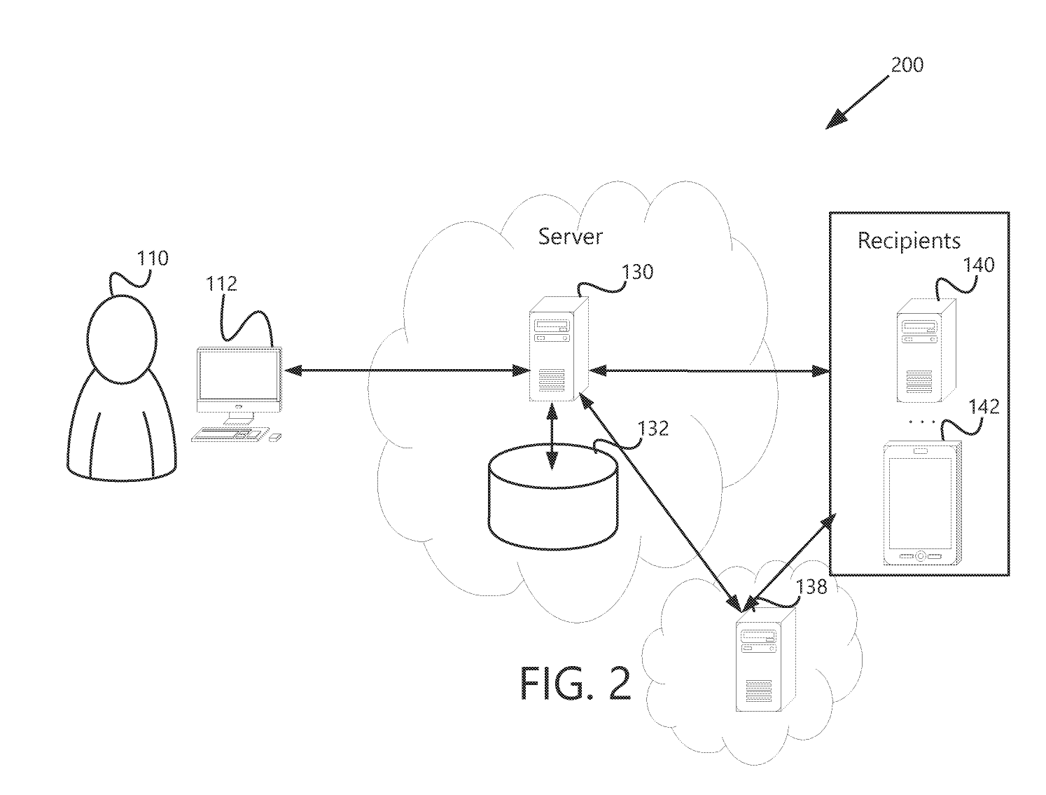

Turning to FIG. 2, an exemplary system 200 for collaborative media sharing is shown. In this example, the user 110 may use his or her computing device 112 to share media by uploading the media to a server 130 in one embodiment. The server 130 may route the uploaded content to a dedicated media server for playback. Alternatively, the server 130 may receive a link to the media, and cause recipient devices to utilize the service that already hosts the media for playback while the server 130 simply synchronizes control of the playback.

Server 130 may comprise one or more servers. For example, server 130 may include a plurality of servers located all over the world at locations convenient for communicating with devices in particular geographic locations. For simplicity, FIG. 2 illustrates only one server, but embodiments with multiple servers for one or more of the entities are contemplated.

The computing devices 112, 140, and 142 may each utilize system 200 software locally on the respective recipient device 140 and 142 to execute playback controls. The software may include a set of instructions stored remotely on a computer-readable medium 132. Each recipient device may access the instructions, such as over the Internet, downloading them to the respective computing device 112, 140, and 142 for local execution. Execution of these instructions by the sender may allow the sender's user device 112 to coordinate with server 130.

Alternatively, the software may be provided as part of a website where the user may upload or stream media content. The website may be based on HTML5, CSS3, JavaScript, and/or various web services. SignalR may be used to provide event-based synchronization between recipient devices in an embodiment. The video.js library may be used to extend media playback support to browsers that fully implement the media element.

The server 130 may store the media file locally in one embodiment, such as at computer-readable medium 132, which may be a database. In another embodiment, the media file is stored on a dedicated content delivery network 138, which caches the file prior to playback.

The server 130 may present a web interface on a recipient device 142 that includes controls to begin playing the media content, which may initiate a streaming sequence with the content delivery network and cause control synchronization across the recipient devices 140 and 142. For example, each recipient 140 and 142 may receive a webpage from the server 130 that includes a portion, such as tag, iFrame, or media player module where the content from content delivery network 138 can stream. Therefore, the media content may stream from content delivery network 138 but the controls may be communicated to the server 130 for replication to the other recipients.

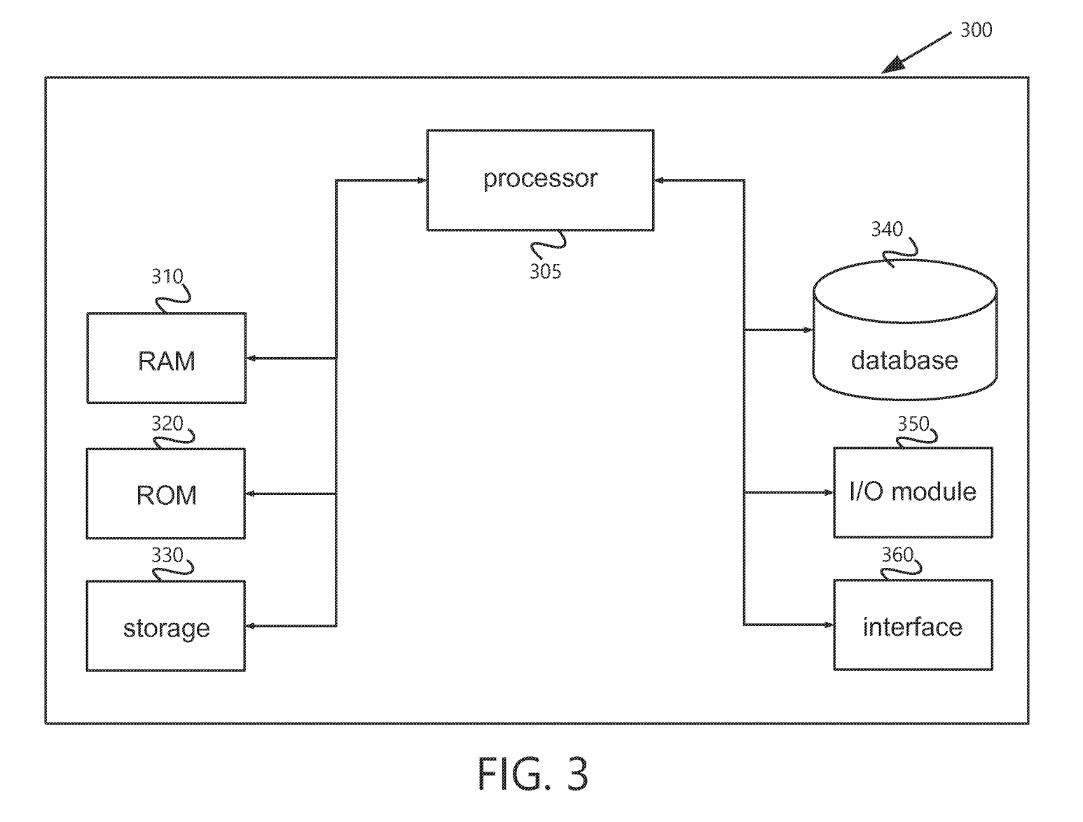

FIG. 3 depicts an exemplary processor-based computing system 300 representative of the type of computing system that may be present in or used in conjunction with a server 130 or device 112, 140, or 142 of FIG. 2. Continuing with FIG. 3, the computing system 300 is exemplary only and does not exclude the possibility of another processor- or controller-based system being used in or with one of the aforementioned components. Additionally, a sharing user device 112 or recipient user device 140 need not include all the system hardware components in an embodiment.

In one aspect, system 300 may include one or more hardware and/or software components configured to execute software programs, such as software for storing, processing, and analyzing data. For example, system 300 may include one or more hardware components such as, for example, processor 305, a random access memory (RAM) module 310, a read-only memory (ROM) module 320, a storage system 330, a database 340, one or more input/output (I/O) modules 350, and an interface module 360. Alternatively and/or additionally, system 300 may include one or more software components such as, for example, a computer-readable medium including computer-executable instructions for performing methods consistent with certain disclosed embodiments. It is contemplated that one or more of the hardware components listed above may be implemented using software. For example, storage 330 may include a software partition associated with one or more other hardware components of system 300. System 300 may include additional, fewer, and/or different components than those listed above. It is understood that the components listed above are exemplary only and not intended to be limiting.

Processor 305 may include one or more processors, each configured to execute instructions and process data to perform one or more functions associated with system 300. The term “processor,” as generally used herein, refers to any logic processing unit, such as one or more central processing units (CPUs), digital signal processors (DSPs), application specific integrated circuits (ASICs), field programmable gate arrays (FPGAs), and similar devices. As illustrated in FIG. 2, processor 305 may be communicatively coupled to RAM 310, ROM 320, storage 330, database 340, I/O module 350, and interface module 360. Processor 305 may be configured to execute sequences of computer program instructions to perform various processes, which will be described in detail below. The computer program instructions may be loaded into RAM for execution by processor 305.

RAM 310 and ROM 320 may each include one or more devices for storing information associated with an operation of system 300 and/or processor 305. For example, ROM 320 may include a memory device configured to access and store information associated with system 300, including information for identifying, initializing, and monitoring the operation of one or more components and subsystems of system 300. RAM 310 may include a memory device for storing data associated with one or more operations of processor 305. For example, ROM 320 may load instructions into RAM 310 for execution by processor 305.

Storage 330 may include any type of storage device configured to store information that processor 305 may need to perform processes consistent with the disclosed embodiments.

Database 340 may include one or more software and/or hardware components that cooperate to store, organize, sort, filter, and/or arrange data used by system 300 and/or processor 305. For example, database 340 may include user-specific account information, including password information as it relates to shared media content. Alternatively, database 340 may store additional and/or different information. Database 340 may also contain a plurality of databases that are communicatively coupled to one another and/or processor 305, which may be one of a plurality of processors utilized by server 130.

I/O module 350 may include one or more components configured to communicate information with a user associated with system 300. For example, I/O module 350 may include a console with an integrated keyboard and mouse to allow a user to input parameters associated with system 300. I/O module 350 may also include a display including a graphical user interface (GUI) for outputting information on a monitor. I/O module 350 may also include peripheral devices such as, for example, a printer for printing information associated with system 300, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Interface 360 may include one or more components configured to transmit and receive data via a communication network, such as the Internet, a local area network, a workstation peer-to-peer network, a direct link network, a wireless network, or any other suitable communication platform. For example, interface 360 may include one or more modulators, demodulators, multiplexers, demultiplexers, network communication devices, wireless devices, antennas, modems, and any other type of device configured to enable data communication via a communication network.

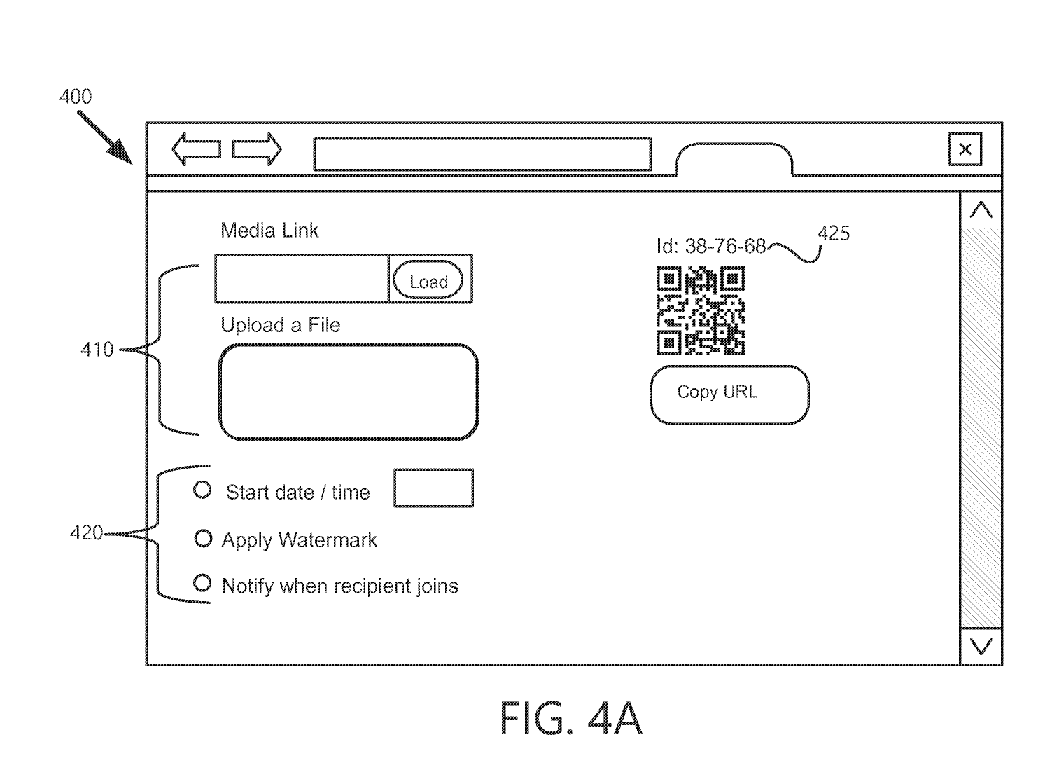

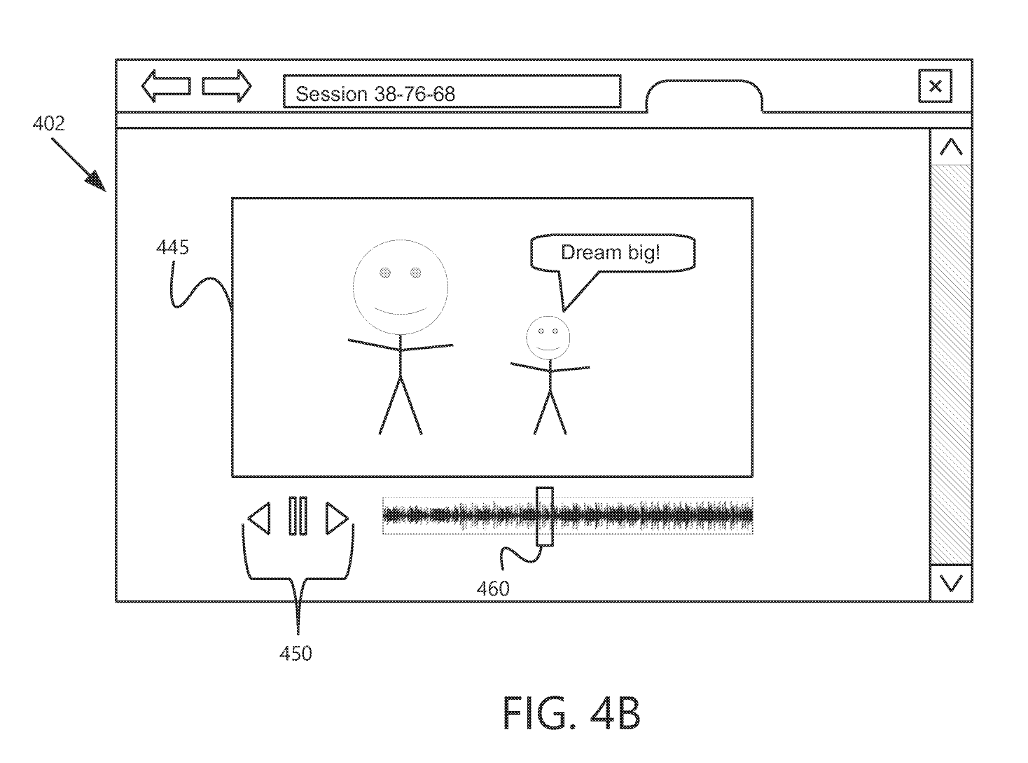

Turning now to FIG. 4A, an exemplary illustration of a browser displaying a webpage 400 GUI on the display of a computing device (such as computing device 112 of FIG. 2) is shown. In this example, a user may input a link to the media content or drag it onto the website to upload it for streaming. Generally, options 410 relate to media selection, whereas options 420 may relate to restrictions placed on playback of the media.

In his example, selecting the media by uploading or linking to it causing the GUI 400 to display a password 425. The webpage 400 may also provide location information for the collaborative playback, such as a QR code that will allow recipients to redirect to the location of the shared media playback. The GUI may also provide a button so that the uploading user may copy the address to the playback location and send it to recipients, along with the password.

An example playback page 402 is presented in FIG. 4B. The playback page 402 may be generated by the server 130 of FIG. 2, but the media 445 for playback may actually be presented in a tag or frame that streams the media content from a content delivery network separate from the server.

The playback page 402 may contain playback controls 450 that are available to each recipient user. When a first recipient uses a control, the server may send corresponding control information to each other recipient that is logged in and collaboratively consuming the media content 445. For example, if a first recipient presses play, the server may be sent a message that causes the server to instruct all the other recipients to also play. Those other recipients may independently stream the media content 445 from the content delivery network, which may be notified by each recipient device or by the server to begin playing. Similarly, a second user selecting pause or stop may cause all of the recipient user playback to pause or stop. The server, therefore, manages replicating each control by a recipient to the other recipients, and the streaming may be managed separately by a network specifically set up to stream content.

Similarly, if a recipient selects a location 460 in the media content to jump to, the server may be notified and promulgate the same location information to the other recipient devices. This may cause the other recipient devices to select the location in the media so that playback will remain synchronized. In one example, a recipient moves a slider and causes the slider to move for all the other recipients on their own devices as well.

This is notably different than current conferencing software, in which media content may play on a user's screen and be mirrored onto screens of other meeting participants. In that case, the conferencing software is tasked with capturing and recording video of the user's screen, which often results in choppy frame rate, lower audio quality, and pixelated video. Conversely, an example of the invention can simply manage synchronizing the playback controls of each recipient, while the recipients maintain their own media streams from the content delivery network. This results in much higher quality collaborative consumption of the media content.

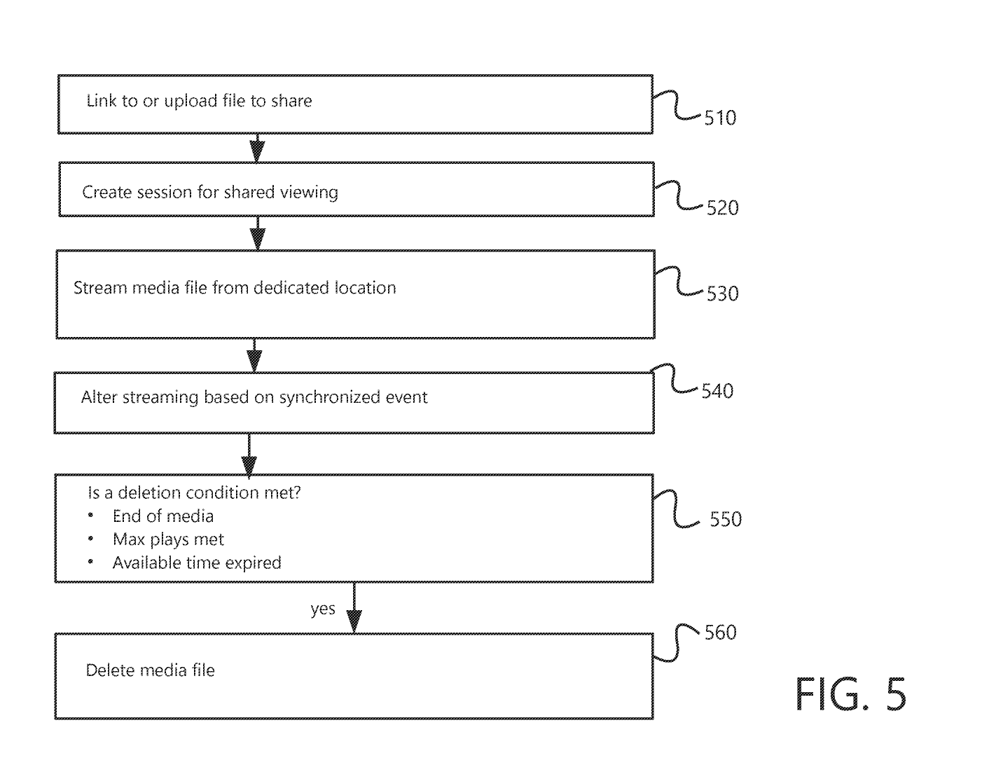

FIG. 5 shows an exemplary flowchart of steps performed by a server 130 to facilitate collaborative media content consumption on a plurality of recipient devices. At step 510, the server receives a link to media content or a file that is uploaded for sharing. If the file is uploaded, the media server can send the file to a content delivery network. The server or device may also receive inputs from a sending user that control when the file can be played synchronously. If a recipient navigates to a link associated with the session prematurely or after the time period has expired, the webpage will not contain the content (e.g., the tag, frame, or media player plugin will not link to the source of the media content).

At step 520, the server may create a session for shared viewing. This can involve issuing a password that the content uploader may forward to a plurality of recipients. Then server creates a session by associating the recipients that login using the password with the session.

At step 530, the server can cause the media content to stream. In one embodiment, this is done by providing controls that a recipient may use, and then directing the content delivery network to being playing based on a recipient hitting play. In one embodiment, the controls on the webpage send communications directly to the content delivery network and also to the server, so that the server may synchronize the event.

At step 540, the server may cause the streaming on a first recipient device to change based on a synchronized event, such as an input from a second recipient device that alters playback on that device. Synchronized events include a location selection within content, pausing the content, playing the content, fast forwarding the content, rewinding the content, or otherwise controlling the content by a first recipient. The server constantly listens for commands by any of the recipients, and then synchronizes the command across the other recipient devices. Although perfect synchronization may not be possible in some cases, sending duplicate commands across all other logged-in recipients to cause the other recipients to consume the media the same way will suffice for synchronization for the purposes of this disclosure.

At step 550, the server can determine if any condition has been met that would require deletion of the media file. In one embodiment, recipients may be able to determine where on the content delivery network the media content is located. The server can cause the media content to be removed, for example, after a conference.

The deletion may occur at step 560. In one aspect, the server deletes the file by automatedly logging into the content delivery network and removing the file.

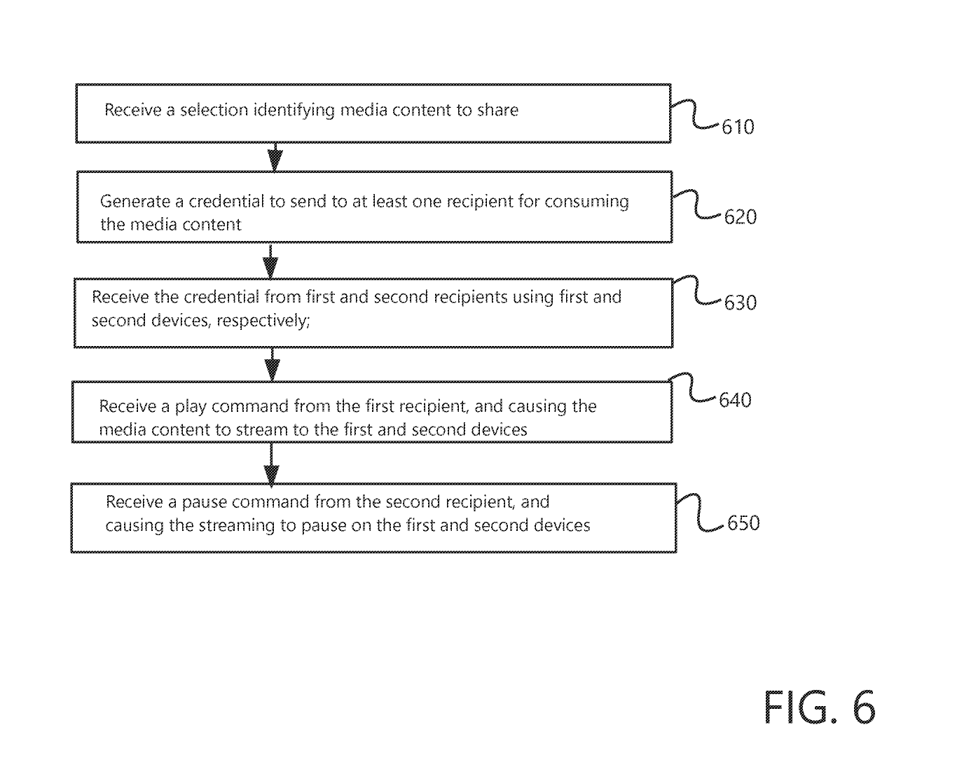

Turning to FIG. 6, additional exemplary steps performed are illustrated that server executes perform collaborative media sharing. At step 610, the server may receive a selection from a user that identifies media content to share.

At step 620, the server may generate a credential (e.g., password) for sharing amongst recipients.

At step 630, the credential is received from first and second recipients. These recipients may be among a plurality of recipients that received the credential.

At step 640, the server may receive a play command from the recipient, and replicate that command to other recipients including the second recipient.

At step 650, the server receives a pause command from the second recipient, which the server then replicates to the other recipients including the first recipient.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system for a shared media player, the system comprising:
a non-transitory computer-readable medium containing instructions;
a communication interface that receives a selection identifying media content to share;
a processor in communication with the interface and the computer-readable medium, wherein the processor executes the instructions to perform stages including:
generating a credential to send to a plurality of recipients for consuming the media content;
receiving the credential from first and second recipients using first and second devices, respectively;
receiving a play command from the first recipient, and causing the media content to stream to the first and second devices; and
receiving a pause command from the second recipient, and causing the streaming to pause on the first and second devices.

2. The system of claim 1, wherein the pause command causes the processor to send a first command to the first device and a second command to the second device by communicating with a module that executes on the first and second devices, respectively.

3. The system of claim 1, wherein causing the media content to stream includes sending a first message to a content delivery server, and wherein causing the streaming to pause includes sending a second message to the content delivery server.

4. The system of claim 1, wherein the processor performs further stages including receiving an input that limits a timeframe within which plurality of recipients may consume the media content.

5. The system of claim 1, wherein the processor performs further stages including generating a network address for use by the plurality of recipients in consuming the content.

6. The system of claim 1, wherein the processor performs further stages including:
receiving, from a third device within the plurality of recipients, a selection to skip to a location in the media content; and
sending first and second messages to the first and second devices to cause the first and second devices to skip to the location in the media content.

7. The system of claim 1, wherein the processor further inserts a watermark into the media content.

8. A non-transitory computer-readable medium containing instructions that are executed by a processor, causing the processor to perform stages including:
receiving a selection identifying media content to share;
generating a credential to send to a plurality of recipients for consuming the media content;
receiving the credential from first and second recipients using first and second devices, respectively;
receiving a play command from the first recipient, and causing the media content to stream to the first and second devices; and
receiving a pause command from the second recipient, and causing the streaming to pause on the first and second devices.

9. The non-transitory computer-readable medium of claim 8, wherein the stages further include sending a first command to the first device and a second command to the second device by communicating with a module that executes on the first and second devices, respectively.

10. The non-transitory computer-readable medium of claim 8, wherein causing the media content to stream includes sending a first message to a content delivery server, and wherein causing the streaming to pause includes sending a second message to the content delivery server.

11. The non-transitory computer-readable medium of claim 8, wherein the stages further include receiving an input that limits a timeframe within which plurality of recipients may consume the media content.

12. The non-transitory computer-readable medium of claim 8, wherein the stages further include generating a network address for use by the plurality of recipients in consuming the content.

13. The non-transitory computer-readable medium of claim 8, wherein the stages further include:
receiving, from a third device within the plurality of recipients, a selection to skip to a location in the media content; and
sending first and second messages to the first and second devices to cause the first and second devices to skip to the location in the media content.

14. The non-transitory computer-readable medium of claim 8, wherein the stages further include inserting a watermark into the media content.

15. A computer-implemented method for collaboratively sharing media content, the method including at least:
receiving a selection identifying media content to share;
generating a credential to send to a plurality of recipients for consuming the media content;
receiving the credential from first and second recipients using first and second devices, respectively;
receiving a play command from the first recipient, and causing the media content to stream to the first and second devices; and
receiving a pause command from the second recipient, and causing the streaming to pause on the first and second devices.

16. The computer-implemented method of claim 15, wherein the method further includes sending a first command to the first device and a second command to the second device by communicating with a module that executes on the first and second devices, respectively.

17. The computer-implemented method of claim 15, wherein causing the media content to stream includes sending a first message to a content delivery server, and wherein causing the streaming to pause includes sending a second message to the content delivery server.

18. The computer-implemented method of claim 15, wherein the method further includes receiving an input that limits a timeframe within which plurality of recipients may consume the media content.

19. The computer-implemented method of claim 15, wherein the method further includes generating a network address for use by the plurality of recipients in consuming the content.

20. The computer-implemented method of claim 15, wherein the method further includes:
receiving, from a third device within the plurality of recipients, a selection to skip to a location in the media content; and
sending first and second messages to the first and second devices to cause the first and second devices to skip to the location in the media content.
